(19) United States
(12) Patent Application Publication
(10) Pub. No.: US 2022/0107847 A1
(43) Pub. Date: Apr. 7, 2022

(54) COMPUTING SYSTEM FOR DETERMINING QUALITY OF VIRTUAL MACHINE TELEMETRY DATA

(71) Applicant: Microsoft Technology Licensing, LLC, Redmond, WA (US)

(72) Inventors: Irene Rogan SHAFFER, Cambridge, MA (US); Gilbert ANTONIUS, Cambridge, MA (US); Abhijith ASOK, Cambridge, MA (US); Brody Christopher BERG, Seattle, WA (US); Abhiram ESWARAN, Redmond, WA (US); Ritesh Ratnakar KINI, Sammamish, WA (US); Edward Kwong Yi TIONG, Cambridge, MA (US)

(21) Appl. No.: 17/064,685

(22) Filed: Oct. 7, 2020

(51) Int. Cl. G06F 9/50; G06F 9/455; G06N 3/04; G06K 9/62

(52) U.S. Cl. CPC G06F 9/5077; G06F 9/45558; G06F 2009/4557; G06K 9/6256; G06N 3/04

(57) ABSTRACT

A computing system computes a score that is indicative of quality of first telemetry data for a first virtual machine. The computing system computes the score based upon the first telemetry data for the first virtual machine and second telemetry data for a second virtual machine. The first telemetry data comprises first time-series data that identifies first amounts of a computing resource used by the first virtual machine during several time points within a time window. The second telemetry data comprises second time-series data that identifies second amounts of the computing resource used by the second virtual machine during the several time points within the time window. The computing system assigns a label to the first telemetry data based upon the score computed for the first telemetry data, the label is indicative of the quality of the first telemetry data.

### BACKGROUND

A virtual machine is computer-implemented emulation of an actual, physical computing system. Several virtual machines can run on the same physical computing system, wherein each virtual machine executes in an isolated environment from other virtual machines. Virtual machines executing on the same physical computing system may be allocated different types and/or amounts of computing resources of the physical computing system. For instance, a first virtual machine may be allocated a first number of processor cores, whereas a second virtual machine may be allocated a second number of processor cores, wherein the processor cores are provided by the same physical computing system.

In an example, a cloud-based computing platform may provide different virtual machines to different users based upon needs of the users (e.g., individual users, groups of individual users, organizations such as corporations, etc.). For example, a first virtual machine of a first user may host a website of the first user, whereas a second virtual machine of a second user may be utilized to train machine learning models for the second user. Following this example, the first virtual machine may be allocated (and utilize) a relatively large amount of network capacity (i.e., bandwidth) to accommodate visitors to the website of the first user, whereas the second virtual machine may be allocated (and utilize) a relatively large number of processing units to facilitate training of the machine learning models for the second user.

Popularity of cloud-based computing platforms is increasing with users due to performance, configurability, and ease of use of such platforms. However, a cloud-based computing platform has a finite number of actual, physical computing resources that can be allocated to and be used by the virtual machines. When a virtual machine for a user is allocated an insufficient amount of a computing resource, the virtual machine may not be able to adequately perform tasks on behalf of the user. In contrast, when the virtual machine for the user is allocated an amount of the computing resource that is greater than what is actually required by the virtual machine to perform tasks on behalf of the user, physical resources of the computing platform are unnecessarily idle. Thus, it is desirable to recommend a configuration for the virtual machine that optimizes usage of the computing resource such that the computing resource is not under-allocated or over-allocated to the virtual machine.

Conventionally, computing resource allocations to virtual machines (i.e., amounts and types of computing resources allocated to the virtual machines) are dynamically allocated by cloud-based computing platforms through use of rules that have been heuristically developed over time by operators of the cloud-based computing platforms. An example rule may be “if virtual machine X reports usage of at or below CPU Y for a window of time of length Z, then allocate virtual machine X Y+Q CPU for window of time T.” Such rules, however, do not optimize allocation of computing resources of cloud-based computing platforms to virtual machines, resulting in virtual machines being allocated too few resources to perform tasks or over-allocating resources to virtual machines.

To improve upon cloud-based computing platforms that employ predefined rules to allocate computing resources to virtual machines, cloud-based computing platforms have attempted to employ machine learning to learn computer-implemented models, wherein the computer-implemented models, when learned, are configured to dynamically allocate computing resources to virtual machines based upon resources being requested and used by the virtual machines. Telemetry data reported by different virtual machines can be employed as training data for learning the computer-implemented models referenced above. Telemetry data for a virtual machine comprises time-series data that identifies amounts of a computing resource used by the virtual machine during several time points within a time window. In an example, the time-series data may include a first time point and a first value corresponding to the first time point and a second time point and a second value corresponding to the second time point, wherein the first value and the second value are indicative of usage of a computing resource by the virtual machine at the first time point and at the second time point, respectively. In a specific example where the computing resource is central processing unit (CPU) usage, the first value may be a first percentage of the CPU utilized by the virtual machine at the first time point and the second value may be a second percentage of the CPU utilized by the virtual machine at the second time point.

Telemetry data for a virtual machine, however, may contain errors; if telemetry data for several virtual machines includes numerous errors, the telemetry data is not well suited for use as training data for learning a computer-implemented model. Errors in telemetry data for a virtual machine, however, are often not reported in the telemetry data as being errors. In an example, an error may be manifested as a zero value at a time point in telemetry data when in fact the computing resource is being utilized at a non-zero level by the virtual machine at the time point. In another example, however, a zero value may indicate that the virtual machine was actually not using a computing resource at a particular point in time. Hence, it is difficult to distinguish whether a zero value at the time point is an error in the telemetry data or whether the zero represents actual usage of the virtual machine; due to the possibility of the existence of errors in the telemetry data, using the telemetry data as training data for learning a computer-implemented model may result in the model outputting undesirable resource allocations for virtual machines.

### SUMMARY

The following is a brief summary of subject matter that is described in greater detail herein. This summary is not intended to be limiting as to the scope of the claims.

Described herein are various technologies pertaining to evaluating quality of telemetry data generated by virtual machines, wherein the telemetry data is indicative of physical computing resources used by the virtual machines over time. With more specificity, the technologies described herein are configured to compute a score, wherein the score is indicative of the quality of telemetry data (e.g., the score is indicative of the number of errors in the telemetry data). The technologies described herein are also configured to assign a label to the telemetry data based upon the score, wherein the label is indicative of the quality of the telemetry data. Based upon the score and/or the label, the telemetry data may be included or excluded in training data that is used to train a computer-implemented model that, when trained, is configured to dynamically allocate computing resources to virtual machines.

In operation, a computing system receives telemetry data for a plurality of virtual machines. Telemetry data for a virtual machine comprises time-series data that identifies amounts of a computing resource used by the virtual machine during several time points within a time window. In an example, the computing resource may be one or more of a central processing unit (CPU), a graphics processing unit (GPU), a persistent data storage device (e.g., a hard disk drive (HDD), a solid-state drive (SDD), etc.), memory, network capacity (i.e., bandwidth), etc. An amount of a computing resource in the time-series data may be expressed as an absolute amount (e.g., the virtual machine utilizes 1 GB of memory at a time point) or as a percentage of a total amount of the computing resource (e.g., the virtual machine utilizes 12.5% of physical memory of a computing system). Thus, in an example where the computing resource is CPU usage, the time-series data may identify an amount of CPU usage (e.g., 10%, 20%, 0%, etc.) by the virtual machine at a time point. It is contemplated that the plurality of virtual machines may execute in a plurality of geographic regions (e.g., North America, Europe, Asia, etc.). It is further contemplated that different virtual machines within the plurality of virtual machines may be configured to utilize different types and/or amounts of computing resources.

As noted above, telemetry data for a virtual machine may contain errors, and the errors may be manifested as zero values within the time-series data of the telemetry data. For instance, the time-series data may indicate that an amount of a computing resource used by the virtual machine at a time point was zero, when in fact an actual amount of the computing resource used by the virtual machine at the time point was non-zero. Additionally, the virtual machine may not be in continuous operation at all time points (e.g., the virtual machine may be reset, shutdown, idle, etc.) within a time window of the time-series data, and hence the time-series data may also include zero values at time points when the virtual machine was actually not utilizing the computing resource (e.g., due to the virtual machine being idle at the time point). Thus, a zero value for a time point in time series data may indicate (1) that the virtual machine was idle at the time point; or (2) the virtual machine was operating at the time point and the value of zero was erroneously recorded for the time point.

The computing system is configured to compute a score for telemetry data for a virtual machine based upon telemetry data generated for several virtual machines over a time window, wherein the score is indicative of quality of the telemetry data for the virtual machine. More specifically, the score can be a function of three sub-scores: a system sub-score, a region sub-score, and an individual sub-score. Computation of the score is now set forth by way of an example, although it is to be understood that the scope of the subject matter is not limited by the example. In the example, the telemetry data for the plurality of virtual machines includes first telemetry data for a first virtual machine that executes on first computing hardware in a first geographic region, second telemetry data for a second virtual machine that executes on second computing hardware that is in the first geographic region, and third telemetry data for a third virtual machine that executes on computing hardware that is in a second geographic region (collectively referred to in the following example as “the telemetry data”). The first telemetry data comprises first time-series data that identifies first amounts of a computing resource used by the first virtual machine during several time points within a time window, the second telemetry data comprises second time-series data that identifies second amounts of the computing resource used by the second virtual machine during the several time points within the time window, and the third telemetry data comprises third time-series data that identifies third amounts of the computing resource used by the third virtual machine during the several time points within the time window (collectively referred to in the following example as “the time-series data”). In the following example, the computing system computes the score for the first telemetry data for the first virtual machine.

In order to compute the score for the first telemetry data for the first virtual machine, the computing system computes the system sub-score. The computing system computes the system sub-score based upon the telemetry data, regardless of the geographic region in which the first virtual machine operates. The computing system computes the system sub-score for the first telemetry data according to the following procedure. First, for a time point in the time window, the computing system determines whether a value for the time point (considering the time point in each of the first telemetry data, the second telemetry data, and the third telemetry data) is zero greater than a system threshold percentage of time. When the value for the time point in the time-series data is zero greater than the system threshold percentage, the computing system marks the time point as a potential error. Following the example referenced above, if the first time-series data has a value of 0 for the time point, the second time-series data has a value of 0 for the time point, and the third time-series data has a value of 10 for the time point, and the system threshold percentage is 60%, the computing system marks the time point as a potential error, as the percentage of virtual machines that have a zero value corresponding to the time point (66%) exceeds the system threshold percentage (60%). The computing system repeats the aforementioned procedure for each time point in the time window, thereby marking potential errors within the first telemetry data. The computing system computes the system sub-score based upon a number of marked potential errors divided by a (total) number of time points within the time window. Thus, in an example, if the computing system marks 4 time points in the time window as potential errors, and the (total) number of time points within the time window is 10, the computing system computes the system sub-score for the first telemetry data as 4/10, or 0.4.

In order to compute the score for the first telemetry data for the first virtual machine, the computing system also computes the region sub-score. The computing system computes the region sub-score based upon the first telemetry data and the second telemetry data (collectively referred to in the following example as “the region telemetry data”) as the second virtual machine executes on computing hardware that is in the same geographic region as computing hardware upon which the first virtual machine executes. Thus, in the aforementioned example, the computing system utilizes the first time-series data and the second time-series data (referred to in the following example as “the region time-series data”) to compute the region sub-score (as both the first virtual machine and the second virtual machine execute on computing hardware that is located in the first geographic region). The computing system computes the system sub-score according to the following procedure. First, for a time point in the time window, the computing system determines whether a value for the time point (considering the time point in each of the first telemetry data and the second telemetry data) is zero greater than a region threshold percentage of time. When the value for the time point is zero greater than the region threshold percentage and the time point was not previously marked as a potential error during computation of the system sub-score, the computing system marks the time point as a potential error. Following the example referenced above, if the first time-series data has a value of 0 for the time point and the second time-series data has a value of 0 for the time point, the time point has not been previously marked as a potential error during computation of the system sub-score, and the region threshold percentage is 60%, the computing system marks the time point as a potential error, as the percentage of virtual machines that have a zero value for the time point (100%) exceeds the region threshold percentage (60%). The computing system repeats the aforementioned procedure for each time point in the time window, thereby marking potential errors within the first telemetry data. The computing system computes the region sub-score based upon a number of marked potential errors (excluding potential errors that were identified during computation of the system sub-score) divided by the (total) number of time points within the time window. Thus, in an example, if the computing system marks 2 time points in the time window as potential errors, and the (total) number of time points within the time window is 10, the computing system computes the region sub-score for the first telemetry data as 2/10, or 0.2.

In order to compute the score for the first telemetry data for the first virtual machine, the computing system additionally computes an individual sub-score. The individual sub-score is based upon the first telemetry data and the potential errors marked during computation of the system sub-score and the region sub-score. Furthermore, computation of the individual sub-score comprises steps that may mark time points as potential errors in the first telemetry data, as well as steps that may unmark time points as potential errors in the first telemetry data.

In a first step for computing the individual sub-score for the first telemetry data for the first virtual machine, the computing system detects time points in the first time-series data that have a corresponding zero value that have not been previously marked as potential errors that are adjacent to (i.e., immediately before or immediately after) time points that have a zero value that have been marked as potential errors (e.g., as part of the computation of the system sub-score and/or the region sub-score). For example, if the first time-series data includes a zero value at a first time point and a zero value at an adjacent second time point, and the first time point has been previously marked as a potential error, but the second time point has not been previously marked as a potential error, the computing system marks the second time point as a potential error. The computing system repeats this process until no new time points in the first time-series data are detected as potential errors.

In a second step for computing the individual sub-score for the first telemetry data for the first virtual machine, the computing system detects time points in the first time-series data that have a value of zero (that have not previously been marked as potential errors) that are preceded by a sharp fall from a non-zero value to zero and that are followed by a sharp rise from zero to a non-zero value. With more specificity, the computing system computes a mean and a standard deviation for a group of time points that surrounds (but does not include) a time point that has a value of zero (and that has not been previously marked as a potential error). In an example, the group of time points includes three time points that immediately precede the (zero) time point and three time points that immediately follow the (zero) time point (for a total of six time points). In the example, the mean and the standard deviation are computed for values for the six time points. If the standard deviation is zero (i.e., the values for each time point in the group of time points are the same) and a total number of time points in the first time-series data that have a zero value is less than a first threshold amount (e.g., 10), the computing system marks the time point in the first time-series data as a potential error. If the standard deviation is non-zero, the computing system determines whether both a first condition and a second condition are true. As for the first condition, the computing system determines whether zero is less than a certain number of standard deviations (e.g., 2) below the mean. As for the second condition, the computing system determines whether a total number of time points in the first time-series data is less than a second threshold amount (e.g., 15). When both the first condition and the second condition are true, the computing system marks the time point in the first time-series data as a potential error.

In a third step for computing the individual sub-score for the first telemetry data for the first virtual machine, the computing system detects a series of consecutive time points in the first time-series data that each have a value of zero and that each have been marked as a potential error. When a number of time points within the series exceeds a threshold amount, the computing system unmarks the corresponding time points in the series as potential errors. In an example, if the first time-series data includes 25 consecutive time points each having a corresponding zero value and each of the 25 consecutive time points has been previously marked as a potential error, and the threshold value is 20, the computing system unmarks each of the 25 consecutive time points as potential errors in the first time-series data.

In a fourth step for computing the individual sub-score for the first telemetry data for the first virtual machine, the computing system unmarks time points in the first time-series data that were previously detected as potential errors that repeat at a regular interval more than or equal to a threshold number of times. With more particularity, if the first time-series data includes a repeating pattern of consecutive zero values that occur at a repeating interval more than a threshold number of times, the computing system may unmark the time points corresponding to the repeating pattern of consecutive zero values. In a specific example, an amount of time between each time point in the first time series data is 30 minutes, the repeating interval is 48 (indicating daily repetition), and the threshold number of times is 5, indicating that the first telemetry data includes zero values at the same time everyday for 5 consecutive days. Such a pattern is indicative of regularly scheduled shutdowns/restarts of the first virtual machine, and hence the computing system may unmark time points corresponding to the zero values.

Based upon the first step, the second step, the third step, and the fourth step described above, the computing system computes the individual score for the first telemetry data for the first virtual machine. With more specificity, the computing system computes the individual sub-score based upon a number of marked potential errors (excluding the potential errors that were identified during computation of the system sub-score and the potential errors that were identified during the computation of the region sub-score) and the (total) number of time points within the time window. Thus, in an example, if the computing system marks 1 time point in the time window as a potential error (and the 1 time point was not previously marked as a potential error during computation of the system sub-score and/or the region sub-score), and the number of time points within the time window is 10, the computing system can compute the individual sub-score for the first telemetry data as 1/10, or 0.1.

The computing system then computes the score for the first telemetry data for the first virtual machine based upon the system sub-score, the region sub-score, and the individual sub-score. In an embodiment, the computing system may weight each of the system sub-score, the region sub-score, and the individual sub-score prior to computing the score. For instance, the computing system may assign a weight of 2 to both the system sub-score and the region sub-score and a weight of 1 to the individual score. Thus, in the embodiment, the score is the sum of the weighted system sub-score, the weighted region sub-score, and the weighted individual sub-score. In such an example, the range of the score is [0,2]. When the score is 0, the first telemetry data has not been marked with any potential errors, and thus the first telemetry data may be considered to be relatively reliable. When the score is 2, each time point in the first telemetry data has been marked as a potential error, and thus the first telemetry data may be considered to be relatively unreliable. The computing system may compute a score for each computing resource (for which telemetry data is available) utilized by the first virtual machine using the above-described processes. For instance, the computing system may compute a score in which the computing resource is CPU usage, a score in which the computing resource is memory usage, and so forth.

In an example, the computing system computes a first score for CPU usage and a second score for memory usage for the first telemetry data for the first virtual machine. To obtain an overall indicator of the reliability of the first telemetry data for the first virtual machine that accounts for different computing resources used by the first virtual machine, the computing system may average the first score and the second score to obtain an overall score for the first telemetry data. In an embodiment where the score and overall score range from [0,2], the computing system may scale the overall score by multiplying the overall score by 50 to obtain a [0,100] range for the overall score. In the embodiment, the computing system may also invert the overall score by taking the difference between 100 and the overall score. Thus, after inversion, an overall score of 100 indicates that the first telemetry data is relatively reliable, whereas an overall score of 0 indicates that the first telemetry data is relatively unreliable.

The computing system may assign a label to the first telemetry data for the first virtual machine based upon the score, wherein the label indicates the quality of the first telemetry data. The label may be used to determine whether the first telemetry data is to be included in training data for a computer-implemented model, wherein the computer-implemented model is configured to dynamically allocate resources to a virtual machine. When the label indicates that the first telemetry data is of sufficient quality, the first telemetry data may be included in the training data. When the label indicates that the first telemetry data is of insufficient quality, the first telemetry data may be excluded from the training data.

The above-described technologies present various technical advantages. First, the above-described technologies provide a metric by which to gauge quality of telemetry data generated by virtual machines. Second, the above-described technologies facilitate training of a computer-implemented model (e.g., a machine learning model) that allocates physical computing resources to virtual machines. With more specificity, a machine learning model that is trained based upon training data that includes numerous errors will generate suboptimal resource allocations. Through the above-described processes, the computing system described herein may ensure that telemetry data containing a relatively large number of errors is not included in training data for a machine learning model. Thus, by removing “low quality” telemetry data from the training data (based on the score/label assigned to telemetry data), a machine learning model that is trained based upon the training data may recommend configurations for virtual machines that meet the needs of users and that do not result in the under-utilization or over-utilization of computing resources provided to virtual machines.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a data center that executes virtual machines.

FIG. 2 is a functional block diagram of a computing environment that facilitates determining quality of telemetry data generated by virtual machines.

FIG. 3 is a flow diagram that illustrates an exemplary methodology for determining quality of telemetry data generated by a virtual machine.

FIG. 4 is a flow diagram that illustrates an exemplary methodology for determining whether or not to include telemetry data in training data for a computer-implemented model.

FIG. 5 is an exemplary computing device.

### DETAILED DESCRIPTION

Various technologies pertaining to evaluating quality of telemetry data produced by virtual machines are now described with reference to the drawings, wherein like reference numerals are used to refer to like elements throughout. To train a machine learning (ML) model (such as a deep neural network (DNN)), training data must be collected, and for the model to output useful results, the training data must be accurate. Conventionally, training a ML model that is configured to suggest allocation of physical computing resources to virtual machines (VMs) executing on computing hardware in a data center is problematic due to lack of reliable training data. With more specificity, telemetry data for virtual machines that identifies amounts of computing resources used by the virtual machines at different time points over time may include a significant number of errors, such as values of “0” when, in fact, the virtual machines were utilizing hardware resources. If a ML model were trained based upon such telemetry data, the resultant ML model may output resource allocations for VMs that are sub-optimal (such that a computing resource may be over-provisioned to a VM or under-provisioned to the VM). The technologies described herein address such problems by computing a score for telemetry data for a VM, wherein the score is indicative of usability of the telemetry data for training a ML model. As will be described in greater detail herein, the score for the telemetry data (which includes data indicating usage of a computing resource by the VM over a time window) is based upon the telemetry data for the VM and additionally based upon telemetry data for other VMs over the same time window. When the score is above a threshold, the telemetry data can be used as training data for the ML model; contrarily, when the score is below the threshold, the telemetry data is not used as training data for the ML model. Thus, a ML model trained based upon telemetry data for VMs that has been validated through the technologies described herein is improved over conventional technologies for allocating computing resources to VMs, as the ML model is trained based upon telemetry data that is (at least mostly) free of errors.

In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “application”, and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

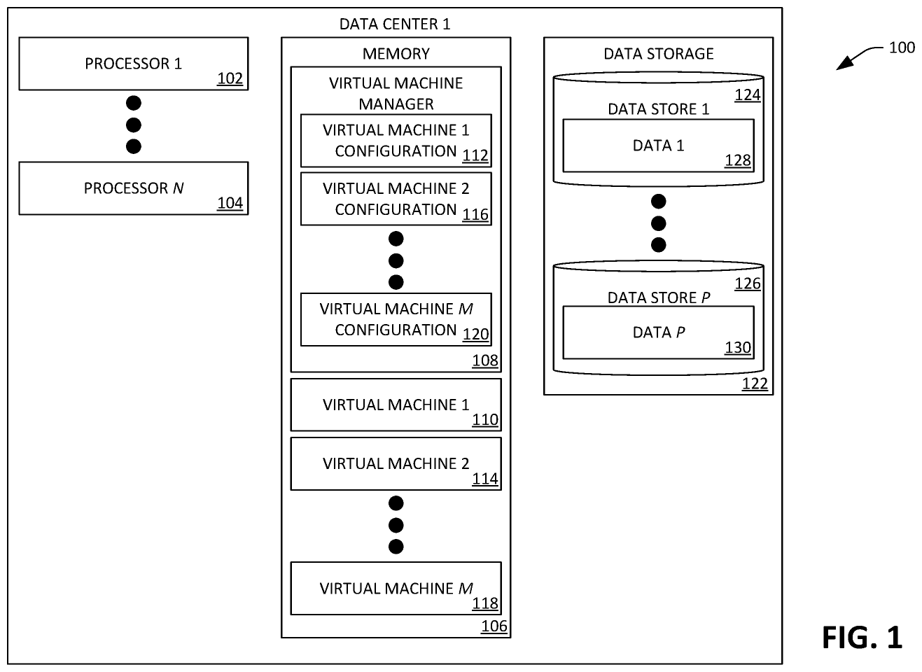

With reference to FIG. 1, an exemplary data center 100 that executes virtual machines is illustrated. The data center 100 comprises a first processor 102 and an Nth processor 104, where N is a positive integer greater than one (collectively referred to herein as “a plurality of processors 102-104”). It is contemplated that processors in the plurality of processors 102-104 may be of different types. For instance, the first processor 102 may have a first number of cores (e.g., eight) that operate at a first frequency and the Nth processor 104 may have a second number of cores (e.g., sixteen) that operate at a second frequency. It is to be understood that the plurality of processors 102-104 may include central processing units (CPUs), as well as graphics processing units (GPUs).

The data center 100 further comprises memory 106. The memory 106 has a virtual machine manager 108 loaded therein. The virtual machine manager 108 is configured to facilitate instantiation and execution of virtual machines in the memory 106. The virtual machine manager 108 instantiates virtual machines in the memory 106 based upon virtual machine configurations, wherein the virtual machines execute applications (not shown in FIG. 1) to perform different tasks. In an example, the virtual machine manager 108 instantiates a first virtual machine 110 in the memory 106 according to a first virtual machine configuration 112. The first virtual machine configuration 112 specifies types and/or amounts of computing resources that are to be provided to and utilized by the first virtual machine 110. In an example, the computing resources that are to be utilized by the first virtual machine configuration 112 may include a number of processors in the plurality of processors 102-104 (or a number of processor cores), types of the processors in the plurality of processors 102-104 (or types of the processor cores), an amount of memory in the memory 106 that is to be allocated to the first virtual machine 110, an amount of data storage (i.e., persistent storage) that is to be allocated to the first virtual machine 110, network capacity (i.e., bandwidth) allocated to the first virtual machine 110, and so forth.

In another example, the virtual machine manager 108 instantiates a second virtual machine 114 according to a second virtual machine configuration 116. The second virtual machine configuration 116 specifies types and/or amounts of computing resources that are to be provided to and utilized by the second virtual machine 114. The second virtual machine configuration 116 may vary from the first virtual machine configuration 112. For instance, the first virtual machine configuration 112 may indicate that the first virtual machine 110 is to utilize a first number of CPU cores, whereas the second virtual machine configuration 116 may indicate that the second virtual machine 114 is to utilize a second number of CPU cores. Thus, it is to be appreciated that the first virtual machine 110 and the second virtual machine 114 may be configured to utilize different types and/or amounts of computing resources depending on respective tasks that are to be performed. In an example, the first virtual machine 110 can be configured to execute a computationally intensive application, and hence the first virtual machine configuration 112 may indicate that the first virtual machine 110 is to utilize a relatively large number of processor cores. In another example, the second virtual machine 114 may be configured to execute a web application, and hence the second virtual machine configuration 116 may indicate that the second virtual machine 114 is to be allocated with a relatively large amount of network capacity to accommodate requests from different users of the web application. It is to be appreciated that the virtual machine manager 108 may instantiate a plurality of virtual machines in the memory 106. For instance, in addition to the first virtual machine 110 and the second virtual machine 114, the virtual machine manager 108 may instantiate an Mth virtual machine 118 according to an Mth virtual machine configuration 120, where M is a positive integer greater than two. Further, the configurations 112-120 can dynamically change as the virtual machines 110-118 request and/or utilize different amounts of computing resources.

The first data center 100 may include data storage 122 that is configured to persistently store data. The data storage 122 may include a first data store 124 and a Pth data store 126, where P is a positive integer greater than one (collectively, “a plurality of data stores 124-126”). The first data store 124 and the Pth data store 126 may store first data 128 and Pth data 130, respectively. In an example, the first data 128 may be data of the first virtual machine 110 and the Pth data 130 may be data of the second virtual machine 114. The plurality of data stores 124-126 may be of different types and/or capacity. In an example, the first data store 124 may be of a first type (e.g., a solid state drive (SSD)) and have a first capacity, and the Pth data store 126 may be of a second type (e.g., hard disk drive (HDD)) and have a second capacity.

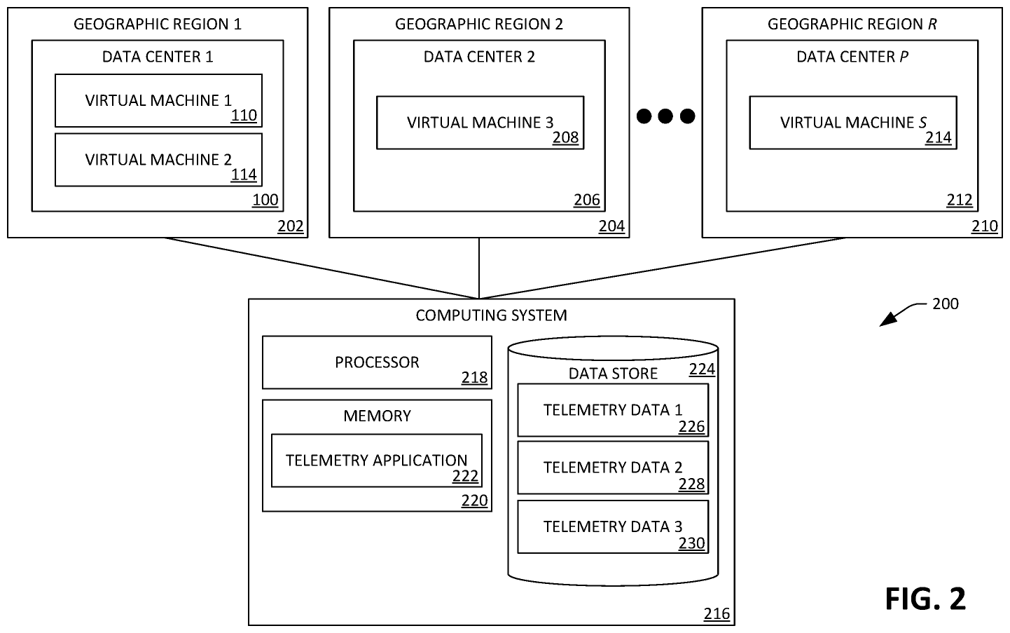

Referring now to FIG. 2, an exemplary computing environment 200 that facilitates evaluating quality of telemetry data of virtual machines is illustrated. The computing environment 200 includes a plurality of data centers that are located in different geographic regions. For instance, the first data center 100 (described in FIG. 1) is located in a first geographic region 202, while a second data center 206 is located in a second geographic region 204. The second data center 206 executes a third virtual machine 208. The second data center 206 may include hardware components similar to those of the first data center 100 (e.g., processors, memory, data storage, etc.) described above.

The computing environment 200 may also include an Rth data center 212 that is located in a Pth geographic region, where both R and P are positive integers greater than 2. Likewise, the Pth data center 212 may execute an Sth virtual machine 214, where S is a positive integer greater than four. The Pth data center 212 may include hardware components similar to those of the first data center 100 (e.g., processors, memory, data storage, etc.) described above. Although not illustrated in FIG. 2, it is to be understood that a geographic region may include more than one data center. Collectively, the first data center 100, the second data center 206, and the Pth data center 212 may be considered to be a cloud-based computing platform.

The computing environment 200 further comprises a computing system 216. The computing system 216 may be in communication with the first data center 100, the second data center 206, and the Pth data center 212 by way of one or more networks (not shown in FIG. 2). In an embodiment, the computing system 216 may be comprised by one or more of the first data center 100, the second data center 206, or the Pth data center 212.

The computing system 216 comprises a processor 218 and memory 220, wherein the memory 220 has a telemetry application 222 loaded therein. As will be described in greater detail below, the telemetry application 222, when executed by the processor 218, is configured to evaluate quality of telemetry data of virtual machines. The computing system 216 may further include a data store 224, wherein the data store 224 is configured to store telemetry data of virtual machines. As such, the data store 224 includes first telemetry data 226 that has been generated for the first virtual machine 110. The first telemetry data 226 comprises first time-series data that identifies amounts of a computing resource used by the first virtual machine 110 during several time points within a time window. In an example, the time window may be eight days, and the time points may be spaced thirty minutes apart, thus leading to 384 time points within the time window. In an example, the computing resource may be one or more of a CPU, a GPU, a data storage device, memory, network capacity, etc. An amount of a computing resource may be expressed as an absolute amount (e.g., the virtual machine utilizes 1 GB of memory at a time point) or as a percentage of a total amount of the computing resource available to the virtual machine (e.g., the virtual machine utilizes 12.5% of X memory at the time point).

The data store 224 further includes second telemetry data 228 that has been generated for the second virtual machine 114. The second telemetry data 228 comprises second time-series data that identifies amounts of the computing resource used by second virtual machine 114 during the several time points within the (same) time window. Furthermore, the data store 224 includes third telemetry data 230 that has been generated by the third virtual machine 208. The third telemetry data 228 comprises third time-series data that identifies amounts of the computing resource used by the third virtual machine 208 during the several time points within the (same) time window. While not shown, the data store 224 may also include Sth telemetry data generated for the Sth virtual machine 214.

Telemetry data for a virtual machine may contain errors, and the errors may manifest themselves as zero values within time-series data of the telemetry data. For instance, the time-series data may indicate that an amount of a computing resource used by the virtual machine at a time point was zero, when in fact an actual amount of the computing resource used by the virtual machine at the time point was non-zero. Additionally, the virtual machine may not be in continuous operation at all time points (e.g., the virtual machine may be idle) within a time window of the time-series data, and hence the time-series data may also include zero values at time points where the virtual machine was actually not utilizing the computing resource due to the virtual machine not being in operation at the time point. Although the examples described herein utilize zero as an error value, it is to be understood that a non-zero value may be the error value in different embodiments.

Operation of the computing environment 200 is now set forth with respect to the first virtual machine 110, the second virtual machine 114, and the third virtual machine 208. More specifically, in the example set forth below, it is presumed that the cloud-based computing platform includes the first data center 100 and the second data center 206 but does not include the Pth data center 212. The first telemetry data 226, the second telemetry data 228, and the third telemetry data 230, are generated for the first virtual machine 100, the second virtual machine 114, and the third virtual machine 208 respectively. The computing system 216 receives the first telemetry data 226 and the second telemetry data 228 from the first data center 100 and that the computing system 216 receives the third telemetry data 230 from the second data center 206. In an example, the computing system 216 receives the first telemetry data 226, the second telemetry data 228, and the third telemetry data 230 as part of a batch.

The telemetry application 222 computes a score for the first telemetry data 226 for the first virtual machine 110, wherein the score is indicative of quality of the first telemetry data 226, and further wherein the score is a function of three sub-scores: (1) a system sub-score, (2) a region sub-score, and (3) an individual sub-score.

The telemetry application 222 computes the system sub-score for the first telemetry data 226 based upon the first telemetry data 226, the second telemetry data 228, and the third telemetry data 230, despite the fact that the virtual machines 110 and 114 are executed on computing hardware that is located in a different region than the hardware upon which the third virtual machine 208 executes. When telemetry data for a large number of virtual machines has a zero value for a time point, it is likely to be an error rather than all of the virtual machines being idle at the same time. The telemetry application 222 computes the system sub-score according to the following procedure. For a time point in the time window, the telemetry application 222 determines whether a value for the time point (considering the time point in each of the first telemetry data 226, the second telemetry data 228, and the third telemetry data 230) is zero greater than a system threshold percentage across all reported values for that time point. When the value for the time point in the time-series data is zero greater than the system threshold percentage, the telemetry application 222 marks the time point as a potential error. Following the example referenced above, if the first time-series data has a value of 0 for the time point, the second time-series data has a value of 0 for the time point, and the third time-series data has a value of 10 for the time point, and the system threshold percentage is 60%, the telemetry application 222 marks the time point as a potential error, as the percentage of virtual machines that have a zero value for the time point (66%) exceeds the system threshold percentage (60%). The telemetry application 222 repeats the aforementioned procedure for each time point in the time window, thereby marking potential errors within the first telemetry data 226. In an example, the telemetry application 222 computes the system-sub score as a number of marked potential errors divided by a (total) number of time points within the time window. Thus, for instance, if the telemetry application 222 marks 4 time points in the time window of the first telemetry data 226 as potential errors, and the (total) number of time points within the time window is 10, the telemetry application 222 computes the system sub-score for the first telemetry data 226 as 4/10, or 0.4.

The telemetry application 222 computes the region sub-score for the first telemetry data 226 based upon telemetry data that is generated by virtual machines that execute on computing hardware that is within the same geographic region as the first virtual machine 110 (i.e., the first geographic region 202). Thus, the telemetry application 222 computes the region sub-score based upon the first telemetry data 226 and the second telemetry data 228 (referred to herein as “region telemetry data 226-228”). When telemetry data for a large number of virtual machines within a region has a zero value for a time point, it is likely to be an error rather than all of the virtual machines in the region being idle at the same time. The telemetry application 222 computes the region sub-score according to the following procedure. First, for a time point in the region telemetry data 226-228, the telemetry application 222 determines whether a value for the time point (considering the time point in each of the first telemetry data 226 and the second telemetry data 228) is zero greater than a region threshold percentage of time. When the value for the time point is zero greater than the region threshold percentage and the time point was not previously marked as a potential error during computation of the system sub-score, the telemetry application 222 marks the time point as a potential error. Following the example referenced above, if the first time-series data has a value of 0 for the time point and the second time-series data has a value of 0 for the time point, the time point has not been previously marked as a potential error during computation of the system sub-score, and the region threshold percentage is 60%, the telemetry application 222 marks the time point as a potential error, as the percentage of virtual machines that have a zero value for the time point (100%) exceeds the region threshold percentage (60%). The telemetry application 222 repeats the aforementioned procedure for each time point in the time window, thereby marking potential errors within the region telemetry data 226-228.

In an example, the telemetry application 222 computes the region sub-score as a number of marked potential errors (excluding potential errors that were identified during the computation of the system sub-score) divided by a (total) number of the time points within the time window. Thus, in an example, if the telemetry application 222 marks 2 time points in the time window of the first telemetry data 226 as potential errors, and the (total) number of time points within the window is 10, the telemetry application 222 computes the region sub-score as 2/10, or 0.2.

The telemetry application 222 computes the individual sub-score for the first telemetry data 226 based upon the first telemetry data 226 and potential errors assigned to time points in the first telemetry data 226 when computing the system sub-score and the region sub-score. Furthermore, computation of the individual sub-score comprises steps that mark time points as potential errors in the first telemetry data 226, as well as steps that unmark time points as potential errors in the first telemetry data 226.

In a first step for computing the individual sub-score for the first telemetry data 226 for the first virtual machine 110, the telemetry application 222 detects time points in the first time-series data that have a corresponding zero value that have not been previously marked as potential errors that are adjacent to (i.e., immediately before or immediately after) time points that have a zero value that have been marked as potential errors (e.g., as part of the computation of the system sub-score and/or the region sub-score). For example, if the first time-series data includes a zero value at a first time point and a zero value at an adjacent second time point, and the first time point has been previously marked as a potential error, but the second time point has not been previously marked as a potential error, the telemetry application 222 marks the second time point as a potential error. The telemetry application 222 repeats this process until no new time points in the first time-series data are detected as potential errors. Detection of zero values in this manner captures zero (error) values that are a continuation of a system-wide or region issue.

In a second step for computing the individual sub-score for the first telemetry data 226 for the first virtual machine 110, the telemetry application 222 detects time points that have a value of 0 (that have not previously been marked as potential errors) that are preceded by a sharp fall from a non-zero value to zero and that are followed by a sharp rise from zero to a non-zero value. With more specificity, the telemetry application 222 computes a mean and a standard deviation for a group of time points that surround (but do not include) a time point that has a value of zero (and that has not been previously marked as a potential error). In an example, the group of time points includes three time points that immediately precede the (zero) time point and three time points that immediately follow the (zero) time point (for a total of six time points). In the example, the mean and the standard deviation are computed for values for the six time points. If the standard deviation is zero (i.e., the values for each time point in the group of time points are the same) and a total number of time points in the first time-series that have a zero value is less than a first threshold amount (e.g., 10), the telemetry application 222 marks the time point as in the first time-series data a potential error. This ensures that the sharp rise/fall is not an inherent pattern in the first time-series data. If the standard deviation is non-zero, the telemetry application 222 determines whether both a first condition and a second condition are true. As for the first condition, the telemetry application 222 determines whether zero is less than a certain number of standard deviations (e.g., 2) below the mean (this is indicative of a relatively “sharp” rise and fall). As for the second condition, the telemetry application 222 determines whether a total number of time points in the first time-series data is less than a second threshold amount (e.g., 15) (this ensures that the appearance of the zero value is not an inherent pattern in the first time-series data). When both the first condition and the second condition are true, the telemetry application 222 marks the time point in the first time-series data as a potential error.

In a third step for computing the individual sub-score for the first telemetry data 226 for the first virtual machine 110, the telemetry application 222 detects a series of consecutive time points in the first time-series data that each have a value of zero and that each have been marked as a potential error. The underlying reason for this step is that a relatively long, consecutive series of zero values in time-series data may be indicative of an actual shutdown of a virtual machine, rather than an error. When a number of time points within the series exceeds a threshold amount, the telemetry application 222 unmarks the corresponding time points in the series as potential errors (i.e., the corresponding time points are no longer identified as potential errors). In an example, if the first time-series data includes 25 consecutive time points each having a corresponding zero value and each of the 25 consecutive time points has been previously marked as a potential error, and the threshold value is 20, the telemetry application 222 unmarks each of the 25 consecutive time points as potential errors in the first time-series data.

In a fourth step for computing the individual sub-score for the first telemetry data 226 for the first virtual machine 110, the telemetry application 222 unmarks time points in the first time-series data that were previously detected as potential errors that repeat at a regular interval more than or equal to a threshold number of times. With more particularity, if the first time-series data includes a repeating pattern of consecutive zero values that occur at a repeating interval more than a threshold number of times, the telemetry application 222 may unmark the time points corresponding to the repeating pattern of consecutive zero values. In a specific example, an amount of time between each time point in the first time series data is 30 minutes, the repeating interval is 48 (indicating daily repetition), and the threshold number of times is 5, indicating that the first telemetry data includes zero values at the same time everyday for 5 consecutive days. Such a pattern is indicative of regularly scheduled shutdowns/restarts of the first virtual machine 110, and hence the telemetry application 222 may unmark time points corresponding to the zero values.

Based upon the first step, the second step, the third step, and the fourth step, the telemetry application 222 computes the individual score for the first telemetry data 226 for the first virtual machine 110. With more specificity, and in an example, the telemetry application 222 computes the individual sub-score as a number of marked potential errors (excluding the potential errors that were identified during computation of the system sub-score and the potential errors that were identified during the computation of the region sub-score) divided by a (total) number of the time points within the time window. Thus, in an example, if the telemetry application 222 marks 1 time point in the time window of the first telemetry data 226 as a potential error (and the 1 time point was not previously marked as a potential error in the computation of the system sub-score and the region sub-score), and the number of time points within the time window is 10, the telemetry application 222 computes the individual sub-score as 1/10, or 0.1.

The telemetry application 222 computes the score for the first telemetry data 226 for the first virtual machine 110 based upon the system sub-score, the region sub-score, and the individual sub-score. In an embodiment, the telemetry application 222 may weight each of the system sub-score, the region sub-score, and the individual sub-score prior to computing the score. The underlying rationale behind weighting is that certain sub-scores (the system sub-score and the region sub-score) may be viewed as more reliable than other sub-scores (e.g., the individual sub-score). Thus, the score may be calculated according to equation (I).

Score=w_{system}system sub-score+w_{region}region sub-score+w_{individual}individual sub-score (I)

For instance, the telemetry application 222 may assign a weight (w_{system}) of 2 to the system sub-score, a weight (w_{region}) of 2 to the region sub-score, and a weight (w_{individual}) of 1 to the individual sub-score. Thus, in the embodiment, equation (I) becomes equation (II).

Score=2(system sub-score+region sub-score)+individual sub-score (II)

In the embodiment, the range of the score is [0,2]. When the score is 0, the first telemetry data 226 has not been marked with any potential errors, and thus the first telemetry data 226 may be considered to be relatively reliable. When the score is 2, each time point in the first telemetry data 226 has been marked as a potential error, and thus the first telemetry data 226 may be considered to be relatively unreliable. The telemetry application 226 may compute a score for each computing resource (for which telemetry data is available) utilized by the first virtual machine 110 using the above-described processes. For instance, the telemetry application 226 may compute a score in which the computing resource is CPU usage, a score in which the computing resource is memory usage, and so forth.

In an example, the telemetry application 222 computes a first score for CPU usage and a second score for memory usage for the first telemetry data 226 for the first virtual machine 110. To obtain an overall indicator of the reliability of the first telemetry data 226 for the first virtual machine 110 that accounts for different computing resources used by the first virtual machine 110, the telemetry application 222 may average the first score and the second score to obtain an overall score for the first telemetry data 226. In an embodiment where the score and overall score range from [0,2], the telemetry application 222 may scale the overall score by multiplying the overall score by 50 to obtain a [0,100] range for the overall score. In the embodiment, the telemetry application 222 may also invert the overall score by taking the difference between 100 and the overall score. Thus, after inversion, an overall score of 100 indicates that the first telemetry data 226 is relatively reliable, whereas an overall score of 0 indicates that the first telemetry data 226 is relatively unreliable. The above-described processes may be repeated for the second telemetry data 228 and the third telemetry data 230 in order to generate respective scores and overall scores for the second telemetry data 228 and the third telemetry data 230.

The telemetry application 222 may assign a label to the first telemetry data 226 for the first virtual machine 110 based upon the score (or the overall score), wherein the label indicates the quality of the first telemetry data 226. The label may be used to determine whether the first telemetry data 226 is to be included in training data for a computer-implemented model (i.e., a machine learning model), wherein the computer-implemented model is configured to recommend resource allocations to virtual machines. When the label indicates that the first telemetry data 226 is of sufficient quality, the first telemetry data 226 may be included in the training data. When the label indicates that the first telemetry data 226 is of insufficient quality, the first telemetry may be excluded from the training data. A computing device may then train the computer-implemented model based upon the training data (with the first telemetry data 226 included or excluded based upon the label).

In an embodiment, after the telemetry application 222 has calculated marked potential errors in the first telemetry data 226 and calculated the score/overall score for the first telemetry data 226, the marked potential errors and the score/overall score may be used for diagnostic and/or troubleshooting purposes. For instance, if the overall score for the first telemetry data 226 is near 0, an engineer may perform troubleshooting on the first virtual machine 110, the virtual machine manager 108, and/or the first data center 100 to determine a source of the (potential) errors. Additionally, the marked potential errors and the score/overall score for the first telemetry data 226 may be presented to a user of the first virtual machine 110 in order for the user to make decisions as to whether or not to change the first virtual machine configuration 112 for the first virtual machine 110.

In an embodiment, the telemetry application 222 may operate in real-time. For instance, the telemetry application 110 may receive the first telemetry data 226, the second telemetry data 228, and the third telemetry data 230 in a rolling window shortly after such data has been generated for the first virtual machine 110, the second virtual machine 114, and the third virtual machine 208, and the telemetry application 110 may calculate the score/overall score for the first telemetry data 226 in real-time.

In an embodiment, the telemetry application 222 may impute values to time points that have been marked as potential errors within the first telemetry data 226. For instance, if a time point in the first telemetry data 222 has a corresponding zero value and the time point has been marked as a potential error, the telemetry application 222 may impute a (non-zero) value to the time point.

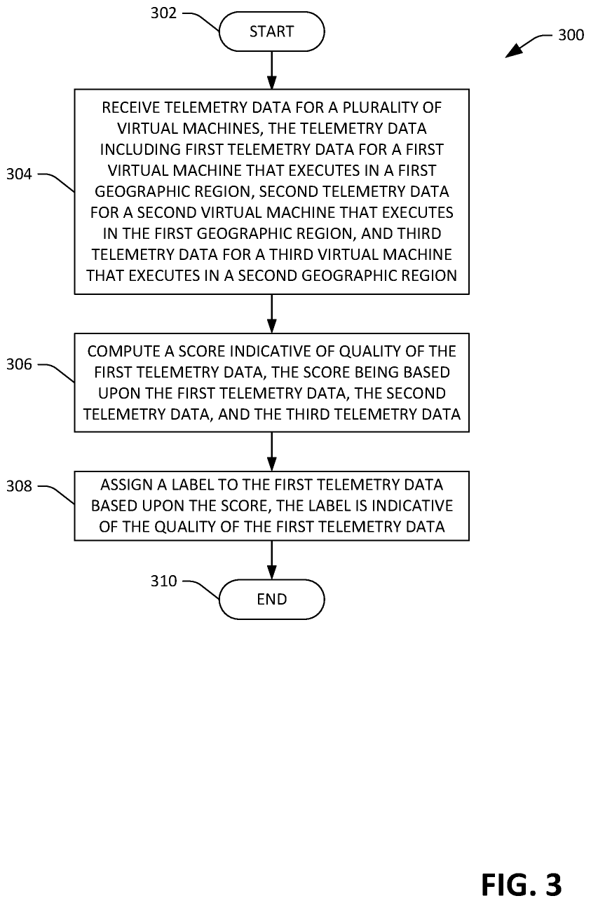

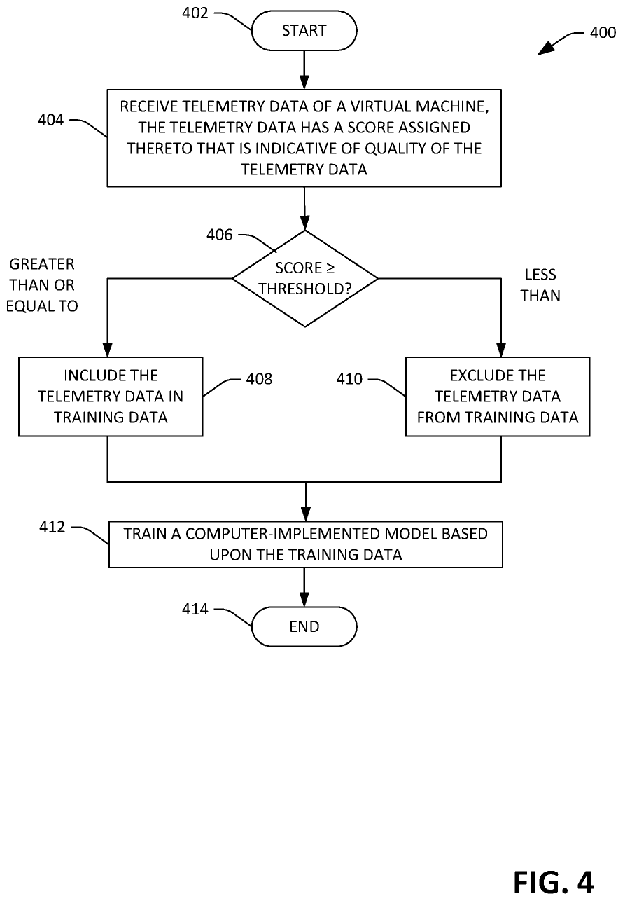

FIGS. 3 and 4 illustrate exemplary methodologies relating to evaluating quality of telemetry data produced by virtual machines. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now to FIG. 3, a methodology 300 that facilitates evaluating quality of telemetry data of a virtual machine is illustrated. The methodology 300 begins at 302, and at 304, the computing system receives telemetry data for a plurality of virtual machines that are executed on computing hardware that is located in a plurality of geographic regions. The telemetry data for the plurality of virtual machines includes first telemetry data, second telemetry data, and third telemetry data. The first telemetry data is for a first virtual machine executed on computing hardware in a first geographic region. The first telemetry data comprises first time-series data that identifies first amounts of a computing resource used by the first virtual machine during several time points within a time window. The second telemetry data is for a second virtual machine executed on computing hardware in the first geographic region. The second telemetry data comprises second time-series data that identifies second amounts of the computing resource used by the second virtual machine during the several time points within the time window. The third telemetry data is for a third virtual machine executed on computing hardware in a second geographic region. The third telemetry data comprises third time-series data that identifies third amounts of the computing resource used by the third virtual machine during the several time points within the time window. At 306, the computing system computes a score that is indicative of quality of the first telemetry data for the first virtual machine, wherein the score is computed based upon the first telemetry data, the second telemetry data, and the third telemetry data. At 308, the computing system assigns a label to the first telemetry data based upon the score computed for the first telemetry data. The label is indicative of the quality of the first telemetry data. The methodology 300 concludes at 310.

Turning now to FIG. 4, a methodology 400 that facilitates determining whether to include telemetry data of a virtual machine in training data for a training a computer-implemented model is illustrated. The methodology 400 begins at 402, and at 404, the computing system receives telemetry data of a virtual machine. The telemetry data comprises time-series data that identifies amounts of a computing resource used by the virtual machine during several time points within a time window. The telemetry data has a score assigned thereto, wherein the score is indicative of quality of the telemetry data. At 406, the computing system determines whether the score is greater than, equal to, or less than a threshold score. At 408, when the score is greater than or equal to the threshold score, the computing system includes the telemetry data in training data. At 410, when the score is less than the threshold score, the computing system excludes the telemetry data from the training data. At 412, the computing system trains a computer-implemented model based upon the training data. The computer-implemented model may be configured to recommend a configuration of a virtual machine (e.g., a number of processor cores, an amount of memory, etc.) for a user, wherein the configuration includes a recommended amount and/or type of the computing resource. The methodology 400 concludes at 414.

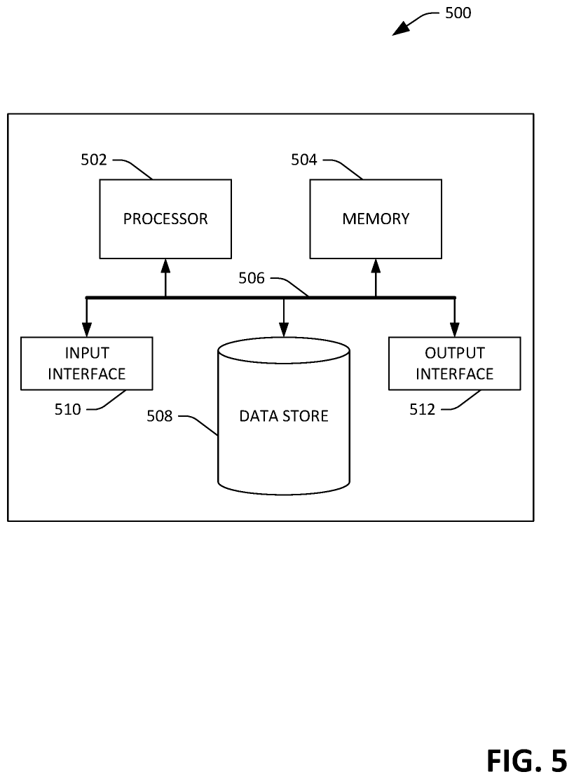

Referring now to FIG. 5, a high-level illustration of an exemplary computing device 500 that can be used in accordance with the systems and methodologies disclosed herein is illustrated. For instance, the computing device 500 may be used in a system that computes a score that is indicative of quality of telemetry data of a virtual machine. By way of another example, the computing device 500 can be used in a system that generates a computer-implemented model that is configured to recommend a configuration of a virtual machine for a user. The computing device 500 includes at least one processor 502 that executes instructions that are stored in a memory 504. The instructions may be, for instance, instructions for implementing functionality described as being carried out by one or more components discussed above or instructions for implementing one or more of the methods described above. The processor 502 may access the memory 504 by way of a system bus 506. In addition to storing executable instructions, the memory 504 may also store virtual machines, telemetry data of virtual machines, computer-implemented models, etc.

The computing device 500 additionally includes a data store 508 that is accessible by the processor 502 by way of the system bus 506. The data store 508 may include executable instructions, virtual machines, telemetry data of virtual machines, computer-implemented models, etc. The computing device 500 also includes an input interface 510 that allows external devices to communicate with the computing device 500. For instance, the input interface 510 may be used to receive instructions from an external computer device, from a user, etc. The computing device 500 also includes an output interface 512 that interfaces the computing device 500 with one or more external devices. For example, the computing device 500 may display text, images, etc. by way of the output interface 512.

It is contemplated that the external devices that communicate with the computing device 500 via the input interface 510 and the output interface 512 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 500 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for instance, several devices may be in communication by way of a network connection and may collectively perform tasks described as being performed by the computing device 500.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise random-access memory (RAM), read-only memory (ROM), electrically erasable programmable read-only memory (EEPROM), compact disc-read-only memory (CD-ROM) or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system, comprising:
a processor; and
memory storing instructions that, when executed by the processor, cause the processor to perform acts comprising:
computing a score that is indicative of usability of first telemetry data for a first virtual machine with respect to training a machine learning (ML) model, wherein the score is computed based upon:
the first telemetry data for the first virtual machine, wherein the first telemetry data comprises first time-series data that identifies first amounts of a computing resource used by the first virtual machine during several time points within a time window; and
second telemetry data for a second virtual machine, wherein the second telemetry data comprises second time-series data that identifies second amounts of the computing resource used by the second virtual machine during the several time points within the time window;
comparing the score to a threshold;
when the score is above the threshold, including the first telemetry data in training data;
when the score is below the threshold, failing to include the first telemetry data in the training data; and
training the ML model with the training data, wherein the ML model, when trained, is configured to allocate the computing resource to virtual machines that are executing on computing hardware in a data center.

2. The computing system of claim 1, wherein the first virtual machine is executed on first computing hardware in a first geographic region, wherein the second virtual machine is executed on second computing hardware in the first geographic region.

3. The computing system of claim 2, wherein the score is additionally computed based upon:
third telemetry data for a third virtual machine, wherein the third telemetry data comprises third time-series data that identifies third amounts of the computing resource used by the third virtual machine during the several time points within the time window, wherein the third virtual machine is executed on third computing hardware in a second geographic region.

4. The computing system of claim 3, wherein computing the score comprises computing a first sub-score, wherein the first sub-score is computed based upon the first telemetry data, the second telemetry data, and the third telemetry data.

5. The computing system of claim 4, wherein computing the score further comprises computing a second sub-score, wherein the second sub-score is computed based upon the first telemetry data and the second telemetry data due to the first virtual machine and the second virtual machine executing on the first computing hardware and the second computing hardware in the first geographic region.

6. The computing system of claim 5, wherein computing the score further comprises computing a third sub-score, wherein the third sub-score is computed based upon the first telemetry data.

7. The computing system of claim 6, wherein computing the score further comprises:
assigning a first weight to the first sub-score, thereby generating a weighted first sub-score;
assigning a second weight to the second sub-score, thereby generating a weighted second sub-score;
assigning a third weight to the third sub-score, thereby generating a weighted third sub-score; and
summing the weighted first sub-score, the weighted second sub-score, and the weighted third sub-score, thereby generating the score.

8. The computing system of claim 1, wherein the computing resource is at least one of:
a central processing unit (CPU);
a graphics processing unit (GPU);
a persistent data storage device;
allocated memory of the first virtual machine; or
network capacity.

9. A method executed by a processor of a computing system, comprising:
selecting training data that is to be used to train a machine learning (ML) model, wherein the ML model, when trained, is configured to allocate a computing resource to virtual machines executing on computing hardware in a data center, wherein selecting the training data comprises:
receiving telemetry data for a plurality of virtual machines that are executed on computing hardware in a plurality of geographic regions, wherein the telemetry data for the plurality of virtual machines includes:
first telemetry data for a first virtual machine executed on first computing hardware in a first geographic region, wherein the first telemetry data comprises first time-series data that identifies first amounts of a computing resource used by the first virtual machine during several time points within a time window;
second telemetry data for a second virtual machine executed on second computing hardware in the first geographic region, wherein the second telemetry data comprises second time-series data that identifies second amounts of the computing resource used by the second virtual machine during the several time points within the time window; and
third telemetry data for a third virtual machine executed on third computing hardware in a second geographic region, wherein the third telemetry data comprises third amounts of the computing resource used by the third virtual machine during the several time points within the time window; and
computing a score that is indicative of usability of the first telemetry data in the training data, wherein the score is computed based upon the first telemetry data, the second telemetry data, and the third telemetry data, wherein the first telemetry data is included in the training data based upon the score;
training the ML model based upon the training data; and
allocating the computing resource to the virtual machines executing on the computing hardware in the data center based upon output of the ML model.

10. The method of claim 9, wherein a time point in the first telemetry data for the first virtual machine has a first value corresponding to the time point, wherein the time point in the second telemetry data for the second virtual machine has a second value corresponding to the time point, wherein the time point in the third telemetry data for the third virtual machine has a third value corresponding to the time point, and further wherein computing the score comprises:
computing a percentage at which a value for the time point is zero based upon whether or not each of the first value, the second value, and the third value are zero at the time point; and
when the percentage exceeds a threshold percentage, marking the time point in the first telemetry data as a potential error, wherein the score is computed based upon the time point in the first telemetry data being marked as the potential error.

11. The method of claim 9, wherein a time point in the first telemetry data for the first virtual machine has a first value corresponding to the time point, wherein the time point in the second telemetry data for the second virtual machine has a second value corresponding to the time point, and further wherein computing the score comprises:
computing a percentage at which a value for the time point is zero based upon whether or not each of the first value and the second value are zero at the time point; and
when the percentage exceeds a threshold percentage, marking the time point in the first telemetry data as a potential error, wherein the score is computed based upon the time point in the first telemetry data being marked as the potential error.

12. The method of claim 9, wherein a time point in the first telemetry data for the first virtual machine has a zero value corresponding to the time point, wherein computing the score comprises:
marking the time point as a potential error based upon:
the zero value for the time point;
a previous value for a previous time point in the first telemetry data for the first virtual machine, the previous time point occurs prior to the time point; and
a subsequent value for a subsequent time point in the first telemetry data for the first virtual machine, the subsequent time point occurs subsequent to the time point,
wherein the score is computed based upon the time point in the first telemetry data being marked as the potential error.

13. The method of claim 9, wherein the first telemetry data comprises a series of consecutive time points each having a corresponding value of zero, wherein each of the series of consecutive time points has been marked as a potential error, wherein computing the score comprises:
unmarking each of the series of consecutive time points as the potential error when a number of time points within the series exceeds a threshold amount, wherein the score is computed based upon each of the series of consecutive time points in the first telemetry data being unmarked as the potential error.

14. The method of claim 9, wherein a value corresponding to a time point in the first telemetry data is zero, thereby indicating one of:
the first virtual machine was idle at the time point; or
the first virtual machine was operating at the time point and the value of zero was erroneously recorded for the time point in the first telemetry data.

15. A computer-readable storage medium comprising instructions that, when executed by a processor of a computing system, cause the processor to perform acts comprising:
allocating varying amounts of a computing resource over time to virtual machines executing on computer hardware in a datacenter, wherein the varying amount of the computing resource are allocated to the virtual machines based upon output of a computer-implemented model, wherein the computer-implemented model is trained with training data that comprises first telemetry data for a first virtual machine, and further wherein the first telemetry data is included in the training data based upon a score that is indicative of usability of the first telemetry data in the training data, the score is computed based upon:
the first telemetry data for the first virtual machine, wherein the first telemetry data comprises first time-series data that identifies first amounts of the computing resource used by the first virtual machine during several time points within a time window; and
second telemetry data for a second virtual machine, wherein the second telemetry data comprises second time-series data that identifies second amounts of the computing resource used by the second virtual machine during the several time points within the time window.

16. The non-transitory computer-readable storage medium of claim 15, the acts further comprising computing the score, wherein computing the score comprises marking a number of the time several time points as potential errors, wherein the score is computed based upon the number.

17. The non-transitory computer-readable storage medium of claim 15, wherein the first virtual machine is executed on first computing hardware in a first geographic region, wherein the second virtual machine is executed on second computing hardware in the first geographic region.

18. The non-transitory computer-readable storage medium of claim 17, wherein the score is additionally computed based upon:
third telemetry data for a third virtual machine, wherein the third telemetry data comprises third time-series data that identifies third amounts of the computing resource used by the third virtual machine during the several time points within the time window, wherein the third virtual machine is executed on third computing hardware in a second geographic region.

19. The non-transitory computer-readable storage medium of claim 15, wherein the computer-implemented model is a deep neural network (DNN).

20. The non-transitory computer-readable storage medium of claim 17, wherein the computing resource is one of:
processor cores; or
memory.
